(19) United States
(12) Patent Application Publication
(10) Pub. No.: US 2025/0360479 A1
(43) Pub. Date: Nov. 27, 2025

(54) CONDUIT ASSEMBLIES FOR A HEAT AND MASS TRANSFER SYSTEM

(71) Applicant: Industrial Climate Solutions Inc., Calgary (CA)

(72) Inventors: Olaf Stallmann, Essenheim (DE); Gianluca Di Federico Mangifesta, Mainz (DE); Christoph Weingärtner, Gau-Algesheim (DE)

(21) Appl. No.: 18/671,334

(22) Filed: May 22, 2024

(51) Int. Cl. B01J 19/00; B01J 19/32

(52) U.S. Cl. CPC B01J 19/0006; B01J 19/0053; B01J 19/32; B01J 2219/00164; B01J 2219/185; B01J 2219/3322

(57) ABSTRACT

A heat and mass transfer system includes at least one vessel configured to receive a gas and a liquid, and a series of heat and mass transfer chambers, each heat and mass transfer chamber of the series of heat and mass transfer chambers configured to receive a portion of the gas and a portion of the liquid, and facilitate heat and mass transfer between the portion of the gas and the portion of the liquid. The portion of the gas and the portion of the liquid flow co-currently during the heat and mass transfer. The heat and mass transfer system also includes a conduit system including a plurality of channels configured to route the gas and the liquid between the heat and mass transfer chambers.

### BACKGROUND

In various industries, including the resource recovery and fluid sequestration industries, capture of various byproducts and/or generated gases may be necessary or desirable. For example, capture of environmentally threatening gasses such as CO₂ from the exhaust streams of hydrocarbon-fueled processes has become a necessity. Regulation of allowable CO₂ emissions now limits the economic viability of power generation and other large scale industrial facility operations. Furthermore, such capture technologies may be used for other chemicals and/or processes, including, without limitation: natural gas production, sweetening, and the like.

### SUMMARY

An embodiment of a heat and mass transfer system includes at least one vessel configured to receive a gas and a liquid, and a series of heat and mass transfer chambers, each heat and mass transfer chamber of the series of heat and mass transfer chambers configured to receive a portion of the gas and a portion of the liquid, and facilitate heat and mass transfer between the portion of the gas and the portion of the liquid. The portion of the gas and the portion of the liquid flow co-currently during the heat and mass transfer. The heat and mass transfer system also includes a conduit system including a plurality of channels configured to route the gas and the liquid between the heat and mass transfer chambers.

An embodiment of a method of transferring heat and mass between fluids includes receiving a gas at a gas inlet of at least one vessel of a heat and mass transfer system, receiving a liquid at a liquid inlet of the at least one vessel, and routing the gas and the liquid through a series of heat and mass transfer chambers by a conduit system. The routing includes directing a portion of the gas and a portion of the liquid via the conduit system into each heat and mass transfer chamber of the series of heat and mass transfer chambers, the conduit system including a plurality of channels. The method also includes transferring heat and mass between the portion of the gas and the portion of the liquid by each heat and mass transfer chamber, where the portion of the gas and the portion of the liquid flow co-currently during the transferring of heat and mass.

An embodiment of a heat and mass transfer system includes a series of vessels configured to receive a gas and a liquid. Each vessel of the series of vessels includes a heat and mass transfer chamber configured to receive a portion of the gas and a portion of the liquid, and facilitate heat and mass transfer between the portion of the gas and the portion of the liquid, where the portion of the gas and the portion of the liquid flow co-currently through each heat and mass transfer chamber. The heat and mass transfer system also includes a conduit system including a plurality of channels configured to route the gas and the liquid between the vessels, wherein the plurality of channels are configured to route the fluid and the gas according to at least one of: a quasi-counter-current flow regime and a quasi-cross-current regime.

### BRIEF DESCRIPTION OF THE DRAWINGS

The following descriptions should not be considered limiting in any way. With reference to the accompanying drawings, like elements are numbered alike:

FIG. 1 depicts an embodiment of a heat and mass transfer system including an internal conduit assembly for directing or routing fluids through heat and mass transfer stages of the system;

FIG. 2 is an exploded view of components of an embodiment of the heat and mass transfer system of FIG. 1;

FIG. 3 is a cross-sectional view of a portion of the heat and mass transfer system of FIG. 1;

FIG. 4 depicts an embodiment of a first conduit assembly configured for inclusion in an embodiment of the heat and mass transfer system of FIG. 1;

FIG. 5 depicts an embodiment of a second conduit assembly configured for inclusion in an embodiment of the heat and mass transfer system of FIG. 1;

FIG. 6 depicts an embodiment of a third conduit assembly configured for inclusion in an embodiment of the heat and mass transfer system of FIG. 1;

FIG. 7 depicts an embodiment of a fourth conduit assembly configured for inclusion in an embodiment of the heat and mass transfer system of FIG. 1

FIG. 8 depicts an embodiment of a heat and mass transfer system that includes a plurality of reaction or absorption stages in series, the heat and mass transfer system being in a quasi-counter-current flow configuration;

FIG. 9 depicts an embodiment of a heat and mass transfer system that includes a plurality of reaction or absorption stages in series, the heat and mass transfer system being in a quasi-counter-current flow configuration;

FIG. 10 depicts an embodiment of a heat and mass transfer system that includes a plurality of reaction or absorption stages in series, the heat and mass transfer system being in a quasi-cross-current flow configuration.

### DETAILED DESCRIPTION

A detailed description of one or more embodiments of the disclosed apparatus and method are presented herein by way of exemplification and not limitation with reference to the Figures.

Systems and methods are described herein for transfer of heat and mass between immiscible fluids having different densities. In an embodiment, the fluids include a gas that is desired to be captured or sequestered, or a gas having one or more components that are desired to be captured or sequestered. For example, the fluids include gas produced from a formation during a hydrocarbon exploration or production process, and a liquid for absorption of desired components. The component(s) to be captured may be carbon dioxide and/or any other compound or component.

In an embodiment, a heat and mass transfer system includes at least one heat and mass transfer stage. For example, the heat and mass transfer system includes a series of heat and mass transfer stages (e.g., absorption stages) vertically arranged in one or more heat and mass transfer vessels. In an embodiment, a conduit system is included within a heat and mass transfer vessel and is configured to circulate or otherwise control the flow of an input gas and liquid (e.g., solvent) through the stages. The conduit system includes a plurality of vertically extending channels (e.g., tubes, such as cylindrical or rectangular tubes, or other conduits or channel structures) that transport gas and liquid among the stages according to a desired flow regime (e.g., counter-current or quasi-counter-current flow). The channels are sized and shaped such that the channels can be disposed within the absorption vessel. In an embodiment, the channels form chambers or compartments for internal heat and mass transfer elements, which reduces or minimizes space requirements of the heat and mass transfer system. In addition, the channels provide for a homogeneous distribution and routing of gas and liquid.

Separation processes, such as absorption or distillation, usually require segregation of components within one or more fluids beyond their simple equilibrium condition. Heat and mass transfer structures that exclusively utilize co-current fluid flow may be limited with regards to achievable performance within one stage. The embodiments described herein provide a number of advantages, including the ability to enable a counter-current or quasi-counter-current flow regime that provides for improved heat and mass transfer beyond this equilibrium limitation.

Another advantage is that embodiments allow for fluid routing within a main pressure vessel containing the heat and mass transfer stages, which avoids the need for expensive external (high-pressure) piping. Disposing fluid conduits within the pressure vessel as described herein allows for the use of relatively thin walled constructions for fluid routing. Other advantages include reduction in the absorption volume required for carbon dioxide capture (e.g., reduced volume for mixed salt and ammonia-based processes). This reduction allows for, e.g., the use of smaller heat and mass transfer vessels and towers as compared to existing systems.

The embodiments may be configured for various types of heat and mass transfer, such as absorption or distillation. The embodiments may be used for desorption or gas saturation (by evaporation of a liquid fluid or vaporization of a component within the liquid), “gas quenching” (e.g., gas cooling by mixing with cold liquid) and other processes.

Embodiments are described in the following as a system for use in a gas absorption service, for illustration purposes. For those skilled in the art, it is understood that heat and/or mass transfer can be desorption from liquid to gas phase, or absorption from gas phase to liquid phase.

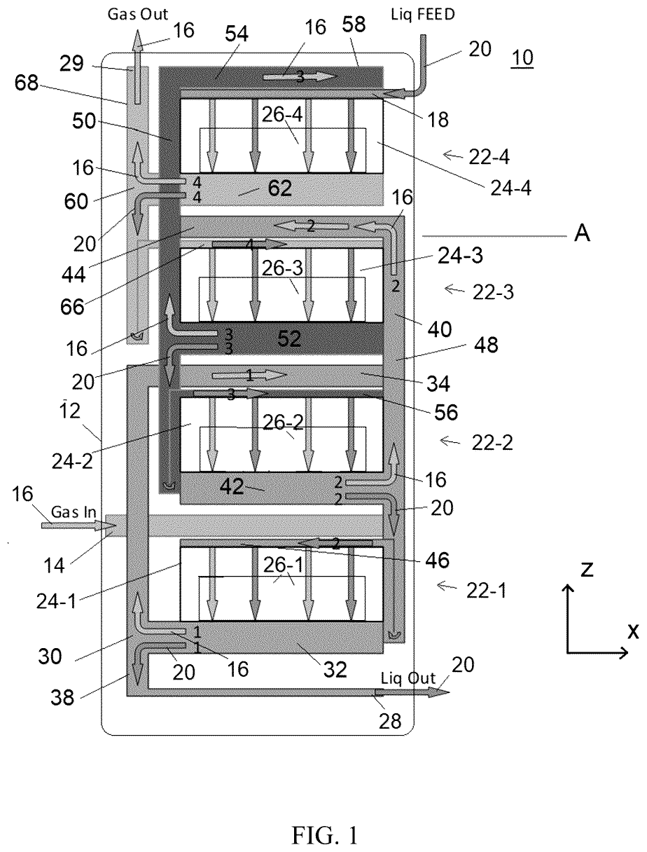

FIG. 1 depicts a heat and mass transfer system 10, e.g., for use in extracting a desired chemical, compound, or material from a fluid. The fluid may be gaseous mixture, such as flue gas from a power plant (e.g., fossil fuel or other fuel source), gas extracted from a subterranean region (e.g., hydrocarbon bearing formation, or any other suitable fluid from which carbon dioxide or other gases is desired to be removed. As discussed further herein, the heat and mass transfer system 10 may operate as an absorption facility that captures a desired material (e.g., carbon dioxide) by flowing an input gas through multiple absorption stages with a liquid solvent.

The heat and mass transfer system 10 includes a reaction or absorption vessel 12 which, as shown, may be a vertically extending vessel. Due to the nature of gas absorption systems, the vessel 12 may, in some uses and configurations, have a height dimension in the vertical direction (z-axis) that is significantly greater than a width dimension (x-axis and/or y-axis). Although illustrated as a cylinder, the vessel 12 may be any suitable shape, and have cross-sections which are circular, oval, rectangular, polyhedral, or other shape. For example, the vessel 12 may be a cylindrical vessel (e.g., for high pressure applications) or a rectangular vessel (e.g., for atmospheric applications).

The vessel 12 includes an inlet gas distribution chamber 14 configured to receive an incoming gas stream 16 (also referred to simply as a gas 16) and direct the gas stream 16 to an absorption stage. The gas stream 16 contains a selected component, such as a gas component, chemical, compound, or the like.

The vessel 12 also includes an inlet 18 (“liquid inlet”) for receiving a liquid composition that provides a mechanism to absorb the desired component to be captured (“target component”). A liquid 20 (e.g., a liquid solvent or any other liquid suitable for absorption) is introduced into the vessel 12 via the liquid inlet 18.

The vessel 12 further includes at least one absorption stage 22. In an embodiment, the system 10 is configured such that each absorption stage 22 operates according to a co-current flow regime, in which the gas 16 and the liquid 20 flow co-currently (i.e., in the same overall direction). For example, as discussed further herein, the gas 16 and the liquid 20 flow vertically downward from a location above an absorption stage 22 to a location below the absorption stage 22. The co-current flow regime significantly intensifies the gas/liquid contact, enhancing the mass transfer.

Any of various liquids or chemical mixtures may be used for capturing the desired material from a gas or fluid. Examples include solvents such as amine-based solvents (e.g., monoethanolamine (MEA)), salt solutions, ammonia-based solvents and others.

For example, embodiments may be used in conjunction with a mixed salts process (MSP) for post-combustion carbon capture based on a solvent formulation with ammonium and potassium carbonate salts. In an example, the MSP solvent is used in conjunction with a Regenerative Froth Contactor (RFC), which is a co-current flow heat and mass transfer device operating in a froth regime, for the absorption function of the MSP process. The RFC can operate as stand-alone absorber in one or multiple stages in place of conventional absorbers, or in conjunction with one or more units of conventional counter-current absorption. The RFC contactor can also operate in a series of units for a quasi-cross-current flow and/or quasi-counter-current regime of the overall series.

In another example, embodiments may be used in conjunction with an ammonia-based solvent as part of a Chilled Ammonia Process (CAP). The CAP is a process for post-combustion carbon capture based on a solvent formulation with ammonia. The CAP solvent may be used with a RFC for the absorption function of the CAP process. The RFC can operate as stand-alone absorber in one or multiple stages in place of conventional absorbers, or in conjunction with one or more units of conventional counter-current absorption. The RFC can also operate in series of units for a quasi-cross-current flow and/or quasi-counter-current regime of the overall series.

Each absorption stage 22 includes a heat and mass transfer chamber 24. In an embodiment, the heat and mass transfer chamber 24 houses one or more packing elements or a packing material, referred to herein as “packing” 26. The packing 26 includes, for example, packing material in the form of a stack of screens or mesh material that provide a high level of surface area while providing through paths to permit a liquid-gas mixture to flow through and interact with the material/structures of the packing 26.

Each heat and mass transfer chambers 24 houses components for absorption of gas components into the liquid 20, which are subsequently referred to as absorption chambers 24. As noted above, the system 10 and the chambers 24 can be configured for other forms of heat and mass transfer (e.g., distillation).

In operation, the liquid 20 and the gas 16 are directed or routed into the absorption chamber 24, and the liquid 20 and gas 16 interact with the packing 26 (also referred to as a “froth generator”) to mix and establish froth droplets and bubbles. In an embodiment, the liquid 20 and the gas 16 are fed from above the absorption chamber 24 and are mixed together and the liquid and the gas flow through the absorption chamber 24.

The packing 26 may be formed of one or more mesh screens, which provide a tortuous flow path through which the gas and liquid of the mixture interact. The screens are configured to burst, shatter, fragment, or break up the bubbles of the aqueous froth into a myriad of droplets and micro-droplets of different radii. For example, the packing 26 includes a plurality of vertically spaced apart mesh screens, where a mesh or screen size may be selected to permit the fluid mixture to pass through but with sufficient obstruction to cause the treatment of the gas-liquid mixture to increase a surface area of the liquid to absorb the gas, as will be appreciated by those of skill in the art.

In an embodiment, the absorption stage or stages is/are configured as a Regenerative Froth Contactor (RFC) system, which can increase the mass-transfer between a gas stream (e.g., carbon-rich flue gasses) and an absorbent liquid solvent. The primary mechanism of an RFC system allows increased mass transfer through the generation of a pulsating flow regime inside a gas-liquid contactor such that the majority of the internal volume of the contactor is occupied by a pulsating froth of micro-scale gas bubbles and liquid droplets. An RFC system may be substantially passive in the sense that the frothing is achieved by supplying a substantially constant pressure and flowrate of the gas and liquid solvent through a vessel having a series of packing elements (e.g., screens or the like).

An RFC may employ specialized Corrugated Screen Packing (CSP) to produce a pulsing gas/liquid flow regime inside the vessel 12. Such pulsing of the gas/liquid mixture may be dependent on the geometric architecture of the packing arrangement (CSP) and the particular flowrates of liquid and gas used.

The system 10 may have a single absorption stage 22, or a plurality of absorption stages. For example, as shown in FIG. 1, the system includes a vertical series of at least two absorption stages 22.

FIG. 1 depicts an example in which in the vessel 12 houses four absorption stages 22 (denoted as stages 22-1, 22-2, 22-3 and 22-4). Each absorption stage 22 includes a respective absorption chamber 24 (denoted as chambers 24-1, 24-2, 24-3 and 24-4) and a respective packing 26-1, 26-2, 26-3 and 26-4).

In an embodiment, the system 10 is arranged in a “quasi-counter-current” configuration. In the quasi-counter-current configuration, the flow of the liquid 20 and the gas 16 is co-current within each absorption stage 22-1, 22-2, 22-3 and 22-4 (i.e., the liquid 20 and the gas 16 flow in the same direction). Also in the quasi-counter-current configuration, the flow of the liquid 20 and the gas 16 flow in opposite directions within other components of the system 10 (including various conduits as discussed further herein).

In this configuration, the gas 16 is directed generally upward and the liquid 20 is directed generally downward. However, both the liquid 20 and the gas 16 are caused to flow downward through each absorption chamber 24.

For example, in the quasi-counter-current configuration shown, the liquid 20 flows through the uppermost absorption stage 22-4, and travels in a generally downward direction. The liquid 20 is successively fed via fluid conduits through each stage 22 (at which the liquid 20 absorbs some of the target component) and to an outlet 28. For example, the liquid 20 is fed through the liquid inlet 20 as a lean solvent, and is output from the liquid outlet 28 as a rich solvent.

The gas 16, in turn, flows into a lowermost absorption stage 22-1, and travels in a generally upward direction through successive absorption stages 22. The gas 16 is output through a gas outlet 29.

To facilitate the transfer to gas and liquid, the system 10 includes various conduits, which are disposed inside of the vessel 12. The conduits include a plurality of vertical conduits, referred to herein as “channels,” which are responsible for transporting liquid and gas upward or downward.

The internal channels are disposed within the vessel 12 (in contrast to existing systems that utilize external piping). The internal channels are shaped and sized to conform to an internal volume of the vessel 12, thereby eliminating the need for external piping. The internal channels may have any suitable cross-sectional shape, such as circular, rectangular and other geometric shapes.

For example, a first channel 30 transports gas 16 from the first absorption chamber 24-1 to the second absorption chamber 24-2, and transports liquid 20 from the first absorption chamber 24-1 to the liquid outlet 20. The first channel 30 is in fluid communication with a collector 32, which receives liquid 20 and gas 16 from the first absorption chamber 24-1. The first channel 30 is also in fluid communication with a gas distribution chamber 34, which receives gas 16 from the channel 30 and feeds the gas 16 into the second absorption chamber 24-2.

A second channel 40 is in fluid communication with a collector 42 that receives a fluid-gas mixture from the absorption chamber 24-2. The second channel 40 transports gas 16 from the second absorption chamber 24-2 (via the collector 42) to a gas distribution chamber 44, from which the gas 16 enters the third absorption chamber 24-3. The second channel 40 also transports the liquid 20 from the collector 42 to an input chamber 46 to feed the liquid 20 to the first absorption chamber 24-1.

A third channel 50 is in fluid communication with a collector 52, which collects liquid and gas from the third absorption chamber 24-3. The third channel 50 transports gas 16 to a gas distribution chamber 54, from which the gas 16 enters the fourth absorption chamber 24-4. Liquid from the collector 52 is transported to an input chamber 56 to feed the liquid 20 to the second absorption chamber 24-2.

A fourth channel 60 is in fluid communication with a collector 62, and transports gas 16 from the fourth absorption chamber 24-4, via the collector 62, to the gas outlet 29. The fourth channel 60 also transports the liquid 20 from the collector 62 to an input chamber 66 to feed the liquid 20 to the first absorption chamber 24-1.

It is noted that additional absorption chambers may be included. For example, if an additional absorption chamber is disposed above the absorption chamber 24-1, the channel 50 may direct the gas 16 to the additional absorption chamber instead of the gas outlet 29.

In an embodiment, one or more channels and/or other components are configured as a manifold or conduit assembly. Each conduit assembly may be formed as a single structure, in which at least one channel is attached to (or integrated with) a gas distribution chamber and/or a collector. One or more of the conduit assembly structures define chambers or compartments in which packing elements are supported.

Due to the internal configuration of the channels, the channels can be formed with relatively thin material (e.g., sheet metal) using internal fixing points welded to the vessel's inner wall, in contrast to external piping systems that require relatively thick piping and other structures (e.g., for piping support, etc.) For example, the channels may be formed using sheet metal having a thickness of about 1/16 inch to about ¼ inch, depending on overall dimensions of the vessel 12.

For example, a first conduit assembly 38 includes the liquid outlet 28, the channel 30, the collector 32, and the gas distribution chamber 34. A second conduit assembly 48 includes the channel 40, the collector 42, and the gas distribution chamber 44. A third conduit assembly 58 includes the collector 52, the gas distribution chamber 54 and the input chamber 56. A fourth conduit assembly 68 includes the gas outlet 29, the channel 60, the collector 62 and the input chamber 66.

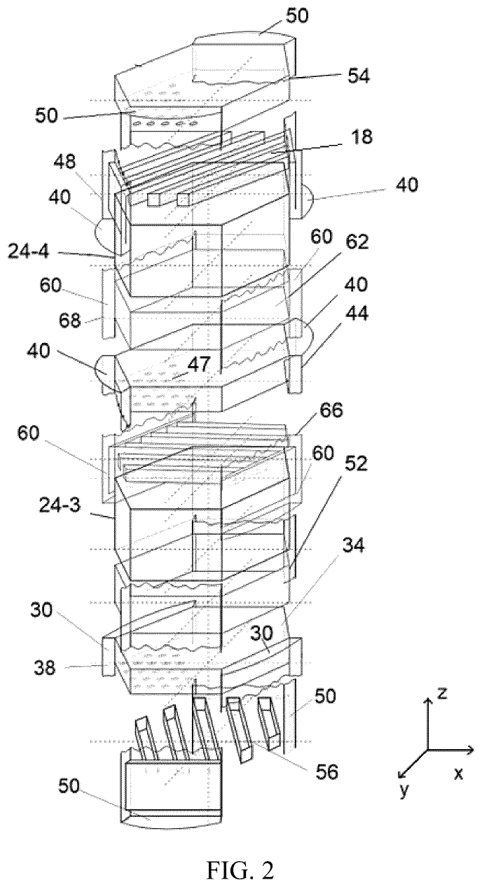

FIG. 2 is an exploded view of parts of the system 10, and shows an example of components configured for use in a cylindrical vessel. In this example, each absorption chamber 24, as well as components disposed between the absorption chambers 24, has a hexagonal cross-section. The hexagonal cross-section provides spaces between the components and the vessel 12 for accommodating the channels 30, 40, 50 and 60.

Also in this example, each conduit assembly includes opposing vertical channels. As discussed above, the conduit assembly 58 includes opposing channels 50 in fluid communication with components as discussed above. Similarly, the conduit assembly 48 includes opposing channels 40, the conduit assembly 38 includes opposing channels 30, and the conduit assembly 68 includes opposing channels 60. In an embodiment, whether each conduit assembly includes one channel or multiple channels, the channels are arranged circumferentially around the absorption chambers 24, and are evenly spaced.

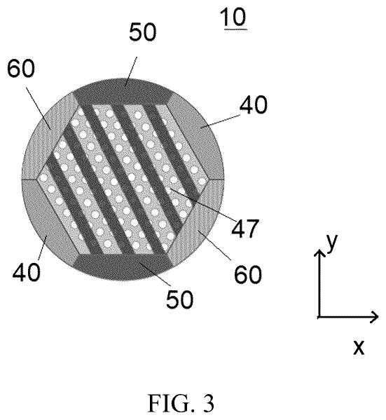

FIG. 3 is a cross-section view of the system 10, defined by a plane located at the gas distribution chamber 44 (and corresponding to line A of FIG. 1). The gas distribution chamber 44 functions to distribute gas over the packing in the absorption chamber 24-3. Gas 16 and liquid 20 enters the chamber via holes 47. FIG. 3 depicts a portion of the system 10, and illustrates an embodiment of a configuration of the channels. In this example, the channels each have a shape with a curved side corresponding to the cylindrical vessel (i.e., an arc with a radius less than or equal to the vessel radius), and an opposing flat side along a boundary of the hexagonal components.

The channels define at least three independent passages for flow of fluids. For example, the conduit assembly 48 includes opposing channels 40 for fluid transport, the conduit assembly 58 includes opposing channels 50, and the conduit assembly 68 includes opposing channels 60. The channels are evenly distributed along the circumference of the vessel 12, i.e., each channel is separate by 60 degrees.

As noted above, the vessel 12 is not limited to a cylindrical shape, and can have any of various shapes, such as an elliptical or polygonal shape. The conduit assemblies and/or channels are shaped and sized to conform to the shape of the vessel 12, such that all of the channels are able to be arranged within an interior volume of the vessel 12.

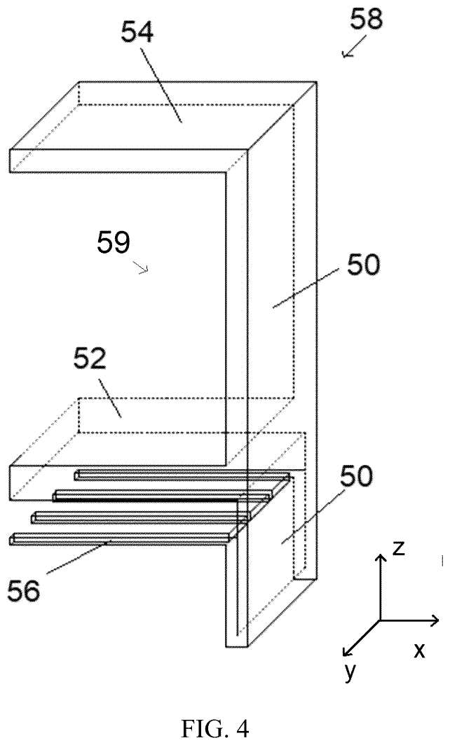

FIGS. 4-7 are perspective views of an example of the conduit assemblies 38, 48, 58 and 68, which are configured for use in a rectangular vessel 12. Each conduit assembly includes a number of rectangular channels, and defines compartments for supporting packing elements. FIGS. 4-7 also show the relative orientations of each conduit assembly. The vertical position of each conduit assembly relative to the absorption chambers 24 is shown in FIG. 1.

FIG. 4 depicts an example of the conduit assembly 58, which defines a rectangular channel 50 having a thickness selected so that the channel 50 fits between the vessel 12 and the various absorption stages. The conduit assembly 58 defines the channel 50, the gas distribution chamber 54 and the input chamber 56, as well as the collector 52. The conduit assembly 58 also defines a compartment 59, which provides a space for insertion of other components of the system 10.

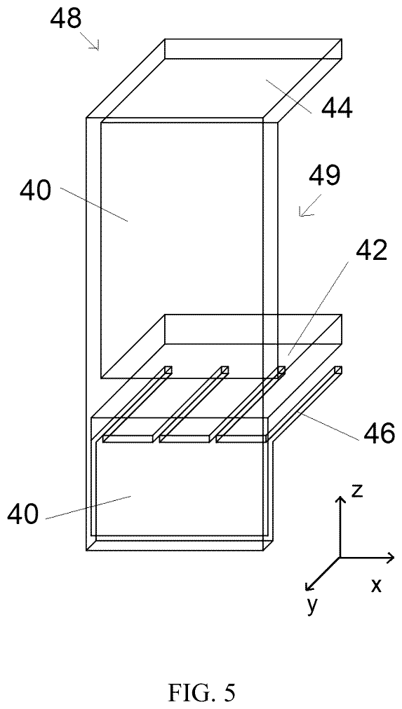

FIG. 5 depicts an example of the conduit assembly 48, which defines a rectangular channel 40, the gas distribution chamber 44, the collector 42 and the input chamber 46. The conduit assembly 48 also defines a compartment 49 for insertion of other components.

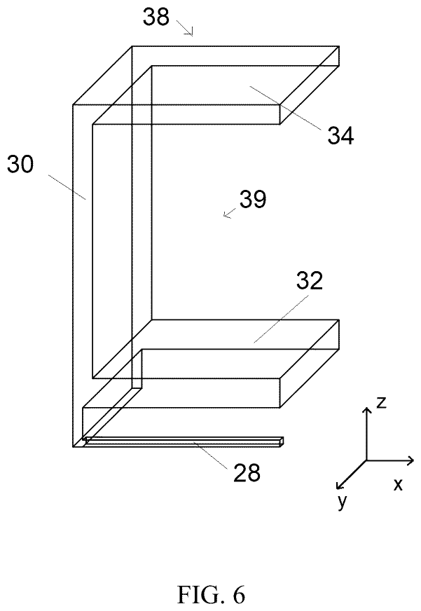

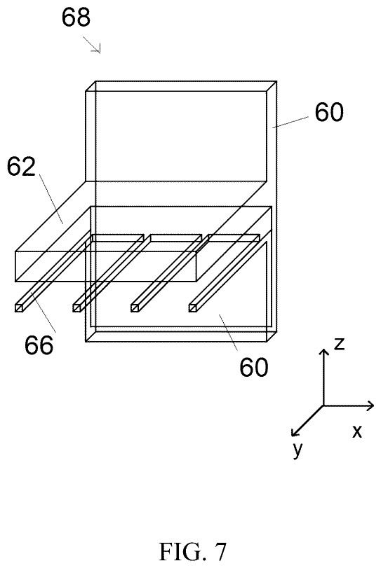

FIG. 6 depicts an example of the conduit assembly 38, which defines a rectangular channel 30, the gas distribution chamber 34, the collector 32 and the outlet 28. The conduit assembly 38 also defines a compartment 39 for insertion of other components. FIG. 7 depicts an example of the conduit assembly 68, which defines a rectangular channel 60, the collector 62 and the input chamber 66.

The conduit assemblies are arranged relative to one another (with the orientations shown in FIGS. 4-7) to form the rectangular vessel 12. This configuration greatly reduces or eliminates any wasted space. The walls (e.g., outer walls) of each conduit (channels 30, 40, 50, 60) may be formed by the walls of the vessel 12, or using common plates for neighboring conduit surfaces. Liquid distributors (the input chambers 46, 56, 66) may be built as standalone items that are inserted into the vapor space above each packing 26.

For example, when assembling the vessel 12, the compartment 59 receives the liquid inlet 18, the packing 26-4, the collector 62, the gas distribution chamber 44, the input chamber 66 and the packing 26-3. The compartment 49 receives the input chamber 66, the packing 26-3, the collector 52, the gas distribution chamber 34, the input chamber 56, and the packing 26-2. The compartment 39 receives the input chamber 56, the packing 26-2, the collector 42, the inlet gas distribution chamber 14, the input chamber 46 and the packing 26-1.

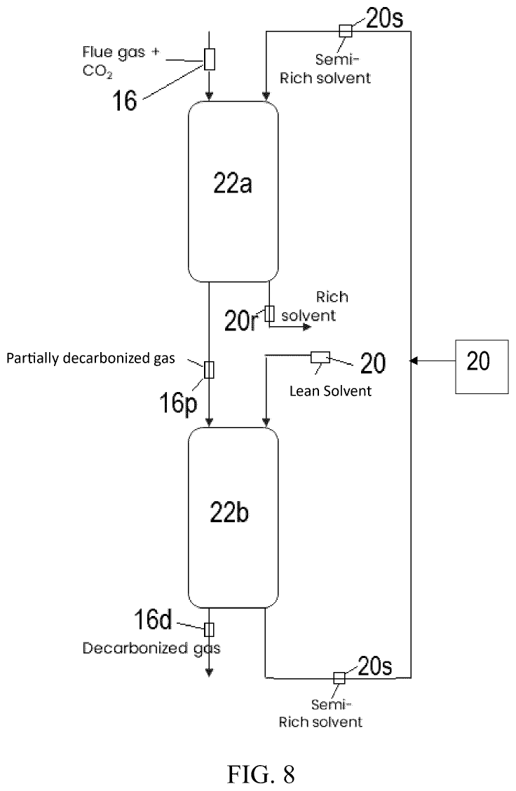

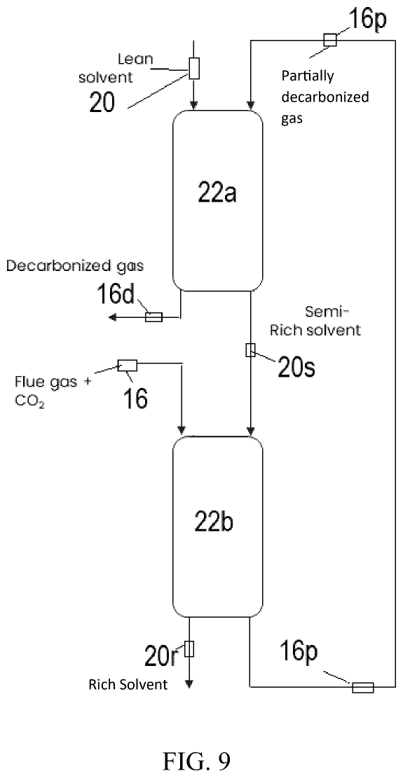

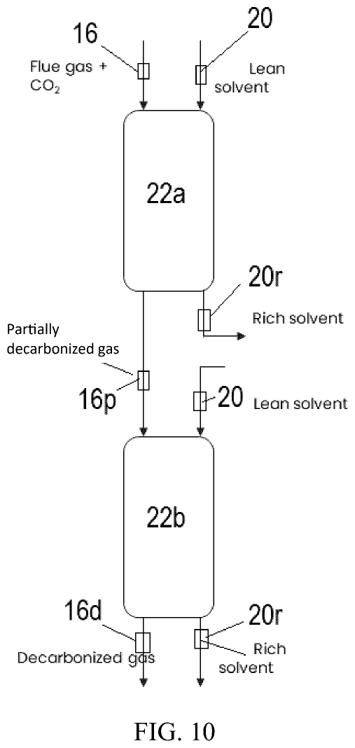

The system 10 may be configured to perform heat and mass transfer using any of various flow regimes. FIGS. 8 and 9 schematically illustrate examples of quasi-counter-current flow regimes and corresponding methods of transferring heat and mass between fluids. FIG. 10 illustrates a quasi-cross-current flow regime and method of transferring heat and mass between fluids.

In these examples, the system 10 includes two absorption stages 22 (denoted as stages 22a and 22b) which are arranged vertically such that the stage 22a is located above the stage 22b. It is noted that the system 10 is not so limited, and may have any number of absorption stages. In addition, each stage could be a separate piece of equipment (e.g., a separate vessel or shell) or the stages could be integrated within a single vessel or other piece of equipment with internal stage separation.

The system 10 includes fluid channels for routing the liquid 20 and the gas 16. The fluid channels may be in a rectangular or cylindrical arrangement as shown in FIGS. 1 and 2, but are not so limited. For example, the absorption stages 22a and 22b can be disposed within a single vessel (e.g., the vessel 12) and connected via internal fluid channels as described above. Alternatively, each stage 22a and 22b is a separate vessel that houses or includes a respective absorption chamber, and the vessels are connected by fluid channels configured to achieve a desired flow regime.

In these examples, the liquid 20 is a solvent such as an aqueous ammonia or other ammonia-based solvent (e.g., as part of a chilled ammonia process or CAP), or a mixed salt solution (e.g., as part of a mixed salt process or MSP). It is noted that any suitable liquid, solution or mixture may be used.

FIG. 8 shows a quasi-counter-current flow regime, in which the gas 16 (e.g., flue gas containing carbon dioxide) is fed to the uppermost stage 22a. The liquid 20 (e.g., chilled ammonia or mixed salt solvent) is fed to the stage 22b (or other lowermost stage if more than two stages are present).

The gas 16 flows through the stage 22a and the stage 22b in a generally downward direction. The liquid 20 enters stage 22b as a lean solvent (e.g., lean ammonia solvent) and interacts with the gas 16 in stage 22b. The resulting semi-rich solvent 20s is routed (e.g. pumped) to stage 22a. Additional solvent 20 may optionally be combined with the semi-rich solvent 20s during the routing.

Within stage 22a, the gas 16 enters and flows co-currently with the semi-rich solvent 20s, where some CO₂ is absorbed, resulting in partially decarbonized gas 16p (e.g., ammonia-rich flue gas). The liquid exits stage 22a as a rich solvent 20r (e.g., ammonia and CO₂-rich solvent). The partially decarbonized gas 16p enters stage 22b, where additional CO₂ is absorbed via interaction with the lean solvent, resulting in decarbonized gas 16d.

The arrangement shown in FIG. 8 has benefits that include a simplified flue gas path, allowing for a relatively simple channel arrangement.

FIG. 9 shows a quasi-counter-current flow regime, in which the gas 16 (e.g., flue gas containing carbon dioxide) is fed to the stage 22b (or other lowermost stage). The liquid 20 (e.g., chilled ammonia or mixed salt solvent) is fed to the uppermost stage 22a, and flows to the stage 22b by gravity (or being pumped, or by a combination of gravity and pumping). Partially decarbonized gas 16p (e.g., is routed to the stage 22a.

At the stage 22a, the liquid 20 (lean solvent) flows co-currently with, and interacts with, the partially decarbonized gas 16p, and decarbonized gas 16d exits the stage 22a. The liquid exits the stage 22a as a semi-rich solvent 20s. Additional solvent may be combined with the semi-rich solvent 20s prior to entering the stage 22b.

At the stage 22b, the gas 16 enters and flows co-currently with the semi-rich solvent 20s, where some CO₂ is absorbed, resulting in the partially decarbonized gas 16p. The liquid exits stage 22a as a rich solvent 20r (e.g., ammonia and CO₂-rich solvent), and the partially decarbonized gas 16p is routed to the stage 22a as noted above.

The arrangement shown in FIG. 9 has benefits that include a reduction in energy consumption. For example, allowing gravity flow of the liquid 20 from a top stage to a bottom stage, reducing or eliminating the need to pump the fluid 20, and thereby reducing equipment needs and energy consumption.

FIG. 10 shows a quasi-cross-current flow regime, in which the gas 16 (e.g., flue gas containing carbon dioxide) and the liquid 20 flow co-currently within each stage and flow cross-currently through the overall system. The gas 16 and the liquid 20 (e.g., lean ammonia solvent) are fed to the uppermost stage 22a. The gas 16 and the liquid flow co-currently and interact to produce rich solvent 20r (e.g., ammonia and CO₂-rich solvent).

Partially decarbonized gas 16p (e.g., ammonia-rich flue gas) is output from the stage 22a and flows into the stage 22b. The liquid 20 is fed to the stage 22b (independent of the stage 22a) and interacts with the partially decarbonized gas 16p. The liquid exits the stage 22b as a rich solvent 20r, and gas 16 exits as decarbonized gas 16d.

Set forth below are some embodiments of the foregoing disclosure:
Embodiment 1: A heat and mass transfer system comprising: at least one vessel configured to receive a gas and a liquid; a series of heat and mass transfer chambers, each heat and mass transfer chamber of the series of heat and mass transfer chambers configured to receive a portion of the gas and a portion of the liquid, and facilitate heat and mass transfer between the portion of the gas and the portion of the liquid, wherein the portion of the gas and the portion of the liquid flow co-currently during the heat and mass transfer; and a conduit system including a plurality of channels configured to route the gas and the liquid between the heat and mass transfer chambers.
Embodiment 2: The heat and mass transfer system of any prior embodiment, wherein the series of heat and mass transfer chambers are arranged in at least one vessel.
Embodiment 3: The heat and mass transfer system of any prior embodiment, wherein each channel of the plurality of channels extends vertically along the length of the at least one vessel and is disposed within the at least one vessel.
Embodiment 4: The heat and mass transfer system of any prior embodiment, wherein each channel has a cross-sectional shape that conforms to a shape of the at least one vessel and permits each channel to be disposed between the series of heat and mass transfer chambers and an interior surface of the at least one vessel.
Embodiment 5: The heat and mass transfer system of any prior embodiment, wherein the at least one vessel is a cylindrical vessel, each channel defines an arcuate surface that follows a portion of a circumference of the at least one vessel, and the plurality of channels is arrayed circumferentially around the series of heat and mass transfer chambers.
Embodiment 6: The absorption system of any prior embodiment, wherein each heat and mass transfer chamber has a hexagonal shape, and each channel defines a flat surface adjacent to a side of a heat and mass transfer chamber and opposing the arcuate surface.
Embodiment 7: The heat and mass transfer system of any prior embodiment, wherein the at least one vessel is a rectangular vessel, and each channel has a rectangular cross-sectional shape.
Embodiment 8: The heat and mass transfer system of any prior embodiment, wherein each heat and mass transfer chamber includes a packing material configured as a regenerative froth contactor (RFC).
Embodiment 9: The heat and mass transfer system of any prior embodiment, wherein the plurality of channels are configured to route the fluid and the gas according to at least one of: a quasi-counter-current flow regime and a quasi-cross-current flow regime.
Embodiment 10: The heat and mass transfer system of any prior embodiment, wherein the liquid is a solvent selected from one of an ammonia-based solvent and a mixed salt solvent.
Embodiment 11: The heat and mass transfer system of any prior embodiment, wherein each channel is part of a conduit assembly, the conduit assembly including at least one of: a gas distribution chamber configured to direct the gas to a first heat and mass transfer chamber, an input chamber configured to direct the liquid to the first heat and mass transfer chamber, and a collector configured to receive the liquid and the gas from a second heat and mass transfer chamber.
Embodiment 12: A method of transferring heat and mass between fluids, the method comprising: receiving a gas at a gas inlet of at least one vessel of a heat and mass transfer system; receiving a liquid at a liquid inlet of the at least one vessel; routing the gas and the liquid through a series of heat and mass transfer chambers by a conduit system, wherein the routing includes directing a portion of the gas and a portion of the liquid via the conduit system into each heat and mass transfer chamber of the series of heat and mass transfer chambers, the conduit system including a plurality of channels; and transferring heat and mass between the portion of the gas and the portion of the liquid by each heat and mass transfer chamber, wherein the portion of the gas and the portion of the liquid flow co-currently during the transferring of heat and mass.
Embodiment 13: The method of any prior embodiment, wherein each channel of the plurality of channels extends vertically along the length of the at least one vessel and disposed within the at least one vessel.
Embodiment 14: The method of any prior embodiment, wherein each channel has a cross-sectional shape that conforms to a shape of the at least one vessel and permits each channel to be disposed between the series of absorption chambers and an interior surface of the at least one vessel.
Embodiment 15: The method of any prior embodiment, wherein the at least one vessel is a cylindrical vessel, each channel defines an arcuate surface that follows a portion of a circumference of the at least one vessel, and the plurality of channels is arrayed circumferentially around the series of absorption chambers.
Embodiment 16: The method of any prior embodiment, wherein each heat and mass transfer chamber has a hexagonal shape, and each channel defines a flat surface adjacent to a side of a heat and mass transfer chamber and opposing the arcuate surface.
Embodiment 17: The method of any prior embodiment, wherein the at least one vessel is a rectangular vessel, and each channel has a rectangular cross-sectional shape.
Embodiment 18: The method of any prior embodiment, wherein each heat and mass transfer chamber includes a packing material configured as a regenerative froth contactor (RFC).
Embodiment 19: The method of any prior embodiment, wherein the plurality of channels is configured to route the fluid and the gas according to a quasi-counter-current flow regime.
Embodiment 20: The method of any prior embodiment, wherein each channel is configured to direct the gas in an upward direction, and is configured to direct the liquid in a downward direction.
Embodiment 21: The method of any prior embodiment, wherein each channel is part of a conduit assembly, the conduit assembly including at least one of: a gas distribution chamber configured to direct the gas to a first heat and mass transfer chamber, an input chamber configured to direct the liquid to the first heat and mass transfer chamber, and a collector configured to receive the liquid and the gas from a second heat and mass transfer chamber.
Embodiment 22: A heat and mass transfer system comprising: a series of vessels configured to receive a gas and a liquid, wherein each vessel of the series of vessels includes a heat and mass transfer chamber configured to receive a portion of the gas and a portion of the liquid, and facilitate heat and mass transfer between the portion of the gas and the portion of the liquid, wherein the portion of the gas and the portion of the liquid flow co-currently through each heat and mass transfer chamber; and a conduit system including a plurality of channels configured to route the gas and the liquid between the vessels, wherein the plurality of channels are configured to route the fluid and the gas according to at least one of: a quasi-counter-current flow regime a quasi-cross-current flow regime.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A heat and mass transfer system comprising:
at least one vessel configured to receive a gas and a liquid;
a series of heat and mass transfer chambers, each heat and mass transfer chamber of the series of heat and mass transfer chambers configured to receive a portion of the gas and a portion of the liquid, and facilitate heat and mass transfer between the portion of the gas and the portion of the liquid, wherein the portion of the gas and the portion of the liquid flow co-currently during the heat and mass transfer; and
a conduit system including a plurality of channels configured to route the gas and the liquid between the heat and mass transfer chambers.

2. The heat and mass transfer system of claim 1, wherein the series of heat and mass transfer chambers are arranged in at least one vessel.

3. The heat and mass transfer system of claim 1, wherein each channel of the plurality of channels extends vertically along the length of the at least one vessel and is disposed within the at least one vessel.

4. The heat and mass transfer system of claim 1, wherein each channel has a cross-sectional shape that conforms to a shape of the at least one vessel and permits each channel to be disposed between the series of heat and mass transfer chambers and an interior surface of the at least one vessel.

5. The heat and mass transfer system of claim 4, wherein the at least one vessel is a cylindrical vessel, each channel defines an arcuate surface that follows a portion of a circumference of the at least one vessel, and the plurality of channels is arrayed circumferentially around the series of heat and mass transfer chambers.

6. The heat and mass transfer system of claim 5, wherein each heat and mass transfer chamber has a hexagonal shape, and each channel defines a flat surface adjacent to a side of a heat and mass transfer chamber and opposing the arcuate surface.

7. The heat and mass transfer system of claim 4, wherein the at least one vessel is a rectangular vessel, and each channel has a rectangular cross-sectional shape.

8. The heat and mass transfer system of claim 1, wherein each heat and mass transfer chamber includes a packing material configured as a regenerative froth contactor (RFC).

9. The heat and mass transfer system of claim 1, wherein the plurality of channels are configured to route the fluid and the gas according to at least one of: a quasi-counter-current flow regime and a quasi-cross-current flow regime.

10. The heat and mass transfer system of claim 9, wherein the liquid is a solvent selected from one of an ammonia-based solvent and a mixed salt solvent.

11. The heat and mass transfer system of claim 1, wherein each channel is part of a conduit assembly, the conduit assembly including at least one of: a gas distribution chamber configured to direct the gas to a first heat and mass transfer chamber, an input chamber configured to direct the liquid to the first heat and mass transfer chamber, and a collector configured to receive the liquid and the gas from a second heat and mass transfer chamber.

12. A method of transferring heat and mass between fluids, the method comprising:
receiving a gas at a gas inlet of at least one vessel of a heat and mass transfer system;
receiving a liquid at a liquid inlet of the at least one vessel;
routing the gas and the liquid through a series of heat and mass transfer chambers by a conduit system, wherein the routing includes directing a portion of the gas and a portion of the liquid via the conduit system into each heat and mass transfer chamber of the series of heat and mass transfer chambers, the conduit system including a plurality of channels; and
transferring heat and mass between the portion of the gas and the portion of the liquid by each heat and mass transfer chamber, wherein the portion of the gas and the portion of the liquid flow co-currently during the transferring of heat and mass.

13. The method of claim 12, wherein each channel of the plurality of channels extends vertically along the length of the at least one vessel and disposed within the at least one vessel.

14. The method of claim 12, wherein each channel has a cross-sectional shape that conforms to a shape of the at least one vessel and permits each channel to be disposed between the series of heat and mass transfer chambers and an interior surface of the at least one vessel.

15. The method of claim 14, wherein the at least one vessel is a cylindrical vessel, each channel defines an arcuate surface that follows a portion of a circumference of the at least one vessel, and the plurality of channels is arrayed circumferentially around the series of heat and mass transfer chambers.

16. The method of claim 15, wherein each heat and mass transfer chamber has a hexagonal shape, and each channel defines a flat surface adjacent to a side of a heat and mass transfer chamber and opposing the arcuate surface.

17. The method of claim 14, wherein the at least one vessel is a rectangular vessel, and each channel has a rectangular cross-sectional shape.

18. The method of claim 12, wherein each heat and mass transfer chamber includes a packing material configured as a regenerative froth contactor (RFC).

19. The method of claim 12, wherein the plurality of channels is configured to route the fluid and the gas according to a quasi-counter-current flow regime.

20. The method of claim 19, wherein each channel is configured to direct the gas in an upward direction, and is configured to direct the liquid in a downward direction.

21. The method of claim 12, wherein each channel is part of a conduit assembly, the conduit assembly including at least one of: a gas distribution chamber configured to direct the gas to a first heat and mass transfer chamber, an input chamber configured to direct the liquid to the first heat and mass transfer chamber, and a collector configured to receive the liquid and the gas from a second heat and mass transfer chamber.

22. A heat and mass transfer system comprising:
a series of vessels configured to receive a gas and a liquid, wherein each vessel of the series of vessels includes a heat and mass transfer chamber configured to receive a portion of the gas and a portion of the liquid, and facilitate heat and mass transfer between the portion of the gas and the portion of the liquid, wherein the portion of the gas and the portion of the liquid flow co-currently through each heat and mass transfer chamber; and
a conduit system including a plurality of channels configured to route the gas and the liquid between the vessels, wherein the plurality of channels are configured to route the fluid and the gas according to at least one of: a quasi-counter-current flow regime and a quasi-cross-current flow regime.
